(19) United States
(12) Patent Application Publication
(10) Pub. No.: US 2006/0201644 A1
(43) Pub. Date: Sep. 14, 2006

(54) Ink jet printing paper

(75) Inventors: Hidehiko Hashimoto, Ichihara-shi Chiba (JP); Norihiko Nakagawa, Ichihara-shi, Chiba (JP); Masanori Shoji, Minato-ku, Tokyo (JP); Masao Kimura, Chuo-ku, Tokyo (JP); Yasuji Kazumori, Nagaoka-shi,Niigata (JP); Hironaga Miyauchi, Chuo-ku, Tokyo (JP)

Correspondence Address: BUCHANAN, INGERSOLL & ROONEY PC, POST OFFICE BOX 1404, ALEXANDRIA, VA, 22313-1404, US

(73) Assignees: Mitsui Chemicals, INC., Minato-ku (JP); Hokuetsu PAPER MILLS, LTD., Nagaoka-Shi (JP)

(21) Appl. No.: 10/544,654

(22) PCT Filed: Feb. 6, 2004
(86) PCT No.: PCT/JP04/01270

§ 371 Date: Dec. 29, 2005

(30) Foreign Application Priority Data
Feb. 7, 2003 (JP) 2003-031402

(51) Int. Cl. B41M 5/00; D21H 13/14

(52) U.S. Cl. 162/146; 428/32.21

(57) ABSTRACT

An ink jet printing paper which has a degree of bulk equal to or higher than that of non-coated paper, retains the same quality as that of coated type sheet with respect to surface smoothness, sharpness of print images, ink absorbability and water resistance, and shows improved ink strike-through and cockling while being bulky. The ink jet printing paper has an ink receiving layer provided on the base paper with the base paper containing synthetic fiber having a branched form.

### TECHNICAL FIELD

The present invention relates to ink jet printing paper which is to be printed by use of ink. More specifically, the present invention relates to ink jet printing paper showing excellent sharpness of print image and excellent water resistance which is bulky and smooth and has an especially high effect in preventing ink strike-through and cockling.

### BACKGROUND ART

The ink jet printing system generates little noise, requires no such processes as image development and photographic fixing and is capable of performing full-color printing easily. For this reason, the system is used for various printers and is coming into increasingly wide use in recent years. Particularly, the system makes possible forming color images through the use of a computer, reducing the size of printing equipment relatively, and reducing the level of operating and printing sound. Because of these advantages, the system is used as a printing system for facsimile machines and various printers.

Furthermore in recent years, as the performance of ink jet printing equipment improves and their uses increase to meet the requirements for the higher speed and fineness of the ink jet printing systems, there is also a growing demand for higher properties of ink jet printing paper.

First, there is a demand for ink jet printing paper to show more excellent sharpness of images in that it should be higher in the print density of images and brighter and sharper in their color, should be quick in absorbing ink not allowing ink to flow out or run even when print images overlap and should also not allow print dots to spread in the longitudinal or transverse direction to an unnecessarily large extent so that the areas surrounding the print dots is smooth.

Furthermore, with respect to storage stability, ink jet printing paper is also required to allow print images to show excellent water resistance with no ink flowing out even when any print image area gets wet under high-humidity conditions.

In order to meet such requirement, so-called coated-type paper has an ink receiving layer made primarily of a pigment such as silica on the substrate paper so that the sharpness of images will be improved. Furthermore, the water resistance of print images is improved by adding a cationic polymer dye fixing agent to the ink receiving layer. Conventionally, various properties have been added by designing the ink receiving layer.

However, the component making up the ink receiving layer is generally costly, and if the coating amount of the ink receiving layer is reduced to reduce the cost, the problem of ink strike-through may arise in some cases. Ink strike-through is a phenomenon in which the ink penetrates into the substrate base paper due to the inadequate absorptivity of the ink receiving layer. In the broad sense, ink strike-through includes the print appearing on the back side. When the ink penetrates into the base paper, such phenomenon is called “cockling” (the printing paper being in a rippling state). Especially with large-sized paper ink jet printers used for CAD, posters, proof sheets, displays, etc., the amount of ink exhalation is generally larger than that of a usual, personal printer, and the problem of cockling is more serious. A serious extent of the problem of cockling will cause not only a problem in appearance but also an operating trouble of the printer occurring due to the paper coming into contact with the head of the printer.

For this reason, various methods have been proposed to avoid cockling (see Japanese Patent Publication HEI 11-034482, for example). Printing paper for large-sized paper printers is generally large in weight, and resin-coated paper, film and nonwoven fabric (see Japanese Patent Publication 2000-2996670, for example) are used in many cases so that ink will not penetrate into the substrate. However, these have problems such as high cost and unsatisfactory recyclability. In the case of coated-type ink jet printing paper using paper as the substrate, such measures as increasing the thickness of the ink receiving layer containing a pigment such as silica, that is, increasing the amount of the coating agent, and increasing the thickness of the base paper are generally taken as the measures for avoiding ink strike-through and cockling. For this reason, the density of coated-type ink jet printing paper is higher than that of non-coated-type ink jet printing paper. Increasing the thickness of the base paper is good from the viewpoint of cockling. However, all of those measures result in a higher cost per unit area. Increasing the thickness of the base paper by reducing the density of the base paper is possible under a method known to the public (see Japanese Patent Publication 2002-103791, for example), but if the density is simply lowered, the smoothness of the surface of the base paper will decline, and the smoothness of the coated paper surface will be affected. If the smoothness of the surface of the coated paper is inadequate, problems such as a decline in the uniformity of printing and a fall in paper carriageability are liable to arise. Thus, it is necessary to reduce the density of paper without sacrificing its smoothness.

### DISCLOSURE OF THE INVENTION

The inventors of the present invention focused their efforts on making a study and as a result have found that it is possible to produce ink jet printing paper which is bulky and smooth even after the ink receiving layer has been coated, by producing ink jet printing paper using a base paper obtained by mixing natural fiber with synthetic fiber. Furthermore, the inventors have also found that it is possible to improve the problem of cockling and ink strike-through, which has been experienced in the case of printing a large amount of ink and in addition that such ink jet printing paper shows satisfactory surface smoothness and excellent print image sharpness. This has led the inventors to make the present invention.

The object of the present invention is to provide ink jet printing paper which has bulk equal to or higher than that of non-coated-type paper and has the same quality of coated-type paper with respect to surface smoothness, print image sharpness, ink absorptivity and water resistance.

Another object of the present invention is to provide ink jet printing paper having improved ink strike-through and cockling while retaining bulkiness, especially ink jet printing paper which is suitable for a large-sized paper printing and which can be recycled.

The present invention provides ink jet printing paper having an ink receiving layer on the base, and the ink jet printing paper whose base paper contains synthetic fiber is a preferable embodiment of the present invention.

The present invention provides ink jet printing paper having an ink receiving layer on the base, and the ink jet printing paper whose base paper contains synthetic fiber having a branched form is also a preferable embodiment of the present invention.

The present invention provides ink jet printing paper having an ink receiving layer on the base, and the ink jet printing paper whose base paper contains synthetic pulp as the synthetic fiber having a branched form as synthetic fiber is also a preferable embodiment of the present invention.

### BEST MODE OF THE INVENTION

The present invention is to provide ink jet printing paper which has an ink receiving layer on the base paper which contains synthetic fiber, more preferably ink jet printing paper using a base paper obtained by mixing natural fiber with synthetic fiber.

Synthetic fiber

The synthetic fiber used in the present invention may be selected from any synthetic fibers that can be used for making paper by the wet method. Representative examples of the synthetic fiber include polyethylene staples, polypropylene staples, rayon fiber, vinylon fiber, polyester fiber, acrylic fiber, polyethylene/polypropylene composite fiber, polypropylene/polyethylene terephthalate composite fiber, polyethylene/polyethylene terephthalate composite fiber, polyester composite fiber and synthetic pulp.

The form of these synthetic fibers may be either staple or filament as long as they are in such range that they can be used for making paper by means of a paper making machine. However, the preferable range of the average fiber length is 0.1 to 10 mm, preferably 0.1 to 5 mm, more preferably 0.1 to 3 mm. If such synthetic fibers are in these ranges, preferable results can be obtained from the viewpoint of such average fiber length that will make it possible to form practical sheets and produce uniform sheets in the process of paper making.

The synthetic fiber of the present invention is preferably a synthetic fiber which has a branched form. A branched form means a form in which many branches come out of the surface of a fiber. Since use of a synthetic fiber having a branched form as the synthetic fiber of the present invention will make it possible to produce a base paper which has more satisfactory formation and improved bulk and is smooth at the same time, a synthetic fiber having a branched form may be cited as an example of the synthetic fiber of the present invention. Such synthetic fiber having a branched form may be a fiber obtained by turning it secondarily into a branched form by giving a mechanical shock to a filament having a common circular or rectangular cross section or even a polygonal cross section, or a fiber produced in such manner that it will have a branched form in the process of fiber formation. A synthetic fiber having a branched form has a large specific surface area because it is fibrillated. It may be cited as another advantage of such synthetic fiber having a branched form that a considerable extent of such specific surface area can also be retained when such synthetic fiber is used in forming sheets. The fibrils of natural pulp contribute to hydrogen bonding among fibers in the formation of sheet, consequently resulting in a reduction in the specific surface area of the sheet. The case of the aforesaid synthetic fiber is quite a contrast to this phenomenon of natural pulp. As the specific surface area of a sheet increases, the opacity and whiteness of the sheet improve, but an improvement in the opacity contributes to an improvement in the ink strike-through problem and sharpness of print. As an example of such synthetic fiber having a branched form, synthetic pulp may be cited more preferably.

Synthetic Pulp

Examples of the aforesaid synthetic pulp include synthetic pulps comprising as the principal component polyolefin-based resins such as homopolymers of olefins such as polyethylene and polypropylene, and copolymers of ethylene and other a-olefin such as ethylene-propylene copolymer, ethylene-butene-1 copolymer and ethylene4-methylpentene-1 copolymer or synthetic resins such as polystyrene, polymethyl methacrylate, polyacrylonitrile, vinyl chloride resin, vinylidene chloride resin, nylon, polyester and polyfluroroethylene. Out of them, synthetic pulp of polyolefin-based resins is inexpensive and used preferably.

Examples of polyolefin-based resins include homopolymers of olefins such as polyethylene, polypropylene and 4-methylpentene-1 and copolymers of ethylene and other a-olefin such as ethylene-propylene copolymer, ethylene-butene-1 copolymer and ethylene-4-methylpentene-1 copolymer. Out of them, polyethylene and polypropylene are used preferably.

The range of the average fiber length of synthetic pulp is normally 0.1 to 10 mm, particularly preferably 0.1 to 5 mm as mentioned above.

Furthermore, the drainage factor of synthetic pulp is preferably approximately 0.1 to 20 seconds/g from the viewpoint of resultant sheet strength and paper-making properties.

In making pulp from the aforesaid synthetic resin, various additives may be added to such extent that the object of the present invention is not defeated. Examples of such additives include flame retardants, antioxidants, antistatic agents, weathering stabilizers and pigments.

A method known to the public may be applied to produce synthetic pulp from such synthetic resin. This method is explained in detail in Encyclopedia of Chemical Technology 3rd ed., Vol. 19, P420 - 425. The method in which melt spun fiber is cut short and beaten and the method in which melt flash or emulsion flash is conducted first and followed by beating are described there.

For the method for producing the synthetic pulp of the present invention, a method in which the solution or emulsion of a resin composition is flash-spun is suitable. In particular, an emulsion flashing method using polyvinyl alcohol (PVA) as an agent for making it hydrophilic is preferable that makes a pulp having a satisfactory fiber shape suitable for paper making. The addition amount of PVA is preferably 0.01 to 10 wt % against the total amount of the pulp including PVA.

Natural Pulp

As the natural pulp used in the present invention, wood-bleached chemical pulp whose primary representative examples are L-BKP and N-BKP is used. Mechanical pulp such as GP, TMP and BCTMP, non-wood pulp such as kenaf, cotton linter and hemp and waste paper pulp (recycled fiber) may be added as required.

Base Paper

The blending ratio of synthetic fiber and natural pulp differs with the type of the natural pulp used but is normally 10/90 to 80/20 wt %, preferably 20/80 to 70/30 wt %, more preferably 30/70 to 60/40. If a blending ratio of synthetic fiber is less than 10 wt %, the base paper will show an inadequate effect in preventing cockling, and if a blending ratio of synthetic fiber is more than 80 wt %, the base paper will have inadequate strength with the result that it will become liable to be broken in the coating process and economically disadvantageous. A proper blending ratio of synthetic fiber is determined on the basis of the effect on bulk and the effect in preventing cockling.

The density of blended paper comprising synthetic fiber and natural pulp is preferably in the range of 0.5 to 1.0 g/cm³, more preferably in the range of 0.6 to 0.9 g/cm³. If the density is too low, the coating liquid will become liable to sink in the voids among fibers at the time of providing the ink receiving layer with the result that the extent of the decline in smoothness will become larger and the uniformity of printing will tend to decline when the paper is printed by use of an ink jet printer. In such case, the decline in uniformity can be compensated to some extent by increasing the amount of the coating agent, but the bulkiness of the paper which is a characteristic of the ink jet printing paper of the present invention is sacrificed. On the other hand, if the density is too high, the coatability of the base paper will be satisfactory in providing the ink receiving layer, but the ink absorbability of the base paper will tend to fall with the result that the ink absorption rate on the ink receiving layer will drop or ink strike-through will tend to occur.

Further, since the density after the coating of the ink receiving layer changes as the thickness of the base paper increases as a result of the coating of a water-based pigment and its weight increases as a result of coating, the density after the coating of the ink receiving layer is preferably in the range of 0.5 to 0.8 g/cm³.

Additive Chemicals Such As Sizing Agents

Paper strength agents, fillers, alum, retention aids, dyes, fluorescent dyes, etc. are normally used in paper stock. Examples given below can be cited as preferable examples, but the present invention is not limited to these examples.

For paper strength agents, cation starch, polyacrylamide, etc. are used. For fillers, calcium carbonate, talc, clay, synthetic zeolite, calcium silicate, titanium, etc. are used. For retention aids, colloidal silica, polyacrylamide, polyethyleneimine, etc. are used. Dyes and fluorescent dyes are added to control the color of paper, and for them, direct dyes, basic dyes, acid dyes, etc. are used.

For the sizing agent in paper stock, alkylketen dimers (AKD), alkenyl succinic acid anhydride (ASA), neutral rosin, etc. are used when calcium carbonate is used for the filler. Furthermore, when materials other than calcium carbonate are used for the filler, fortified rosin and saponified rosin are mainly used as the sizing agent in paper stock.

Production of Base Paper

The process for producing base paper is not particularly limited, paper-making machines known to the public, namely, Fourdrinier wire, cylinder mould, hybrid formers, gap formers, etc., are used to make base paper through pressing and drying processes. In an intermediate process, starch, polyvinylalcohol, polyacrylamide, etc. singly or in combination, or a coating agent comprising a pigment and a binder as a preliminary coating, may be coated onto base paper by use of a size press, film transfer roll coater, or metering size press. The basis weight of base paper is not particularly limited but is normally in the range of approximately 50 to 200 g/m².

Ink Receiving Layer

The ink receiving layer provided on base paper is made principally of an inorganic pigment and a water-soluble polymer binder. For the inorganic pigment, kaolin, clay, ground calcium carbonate, precipitated calcium carbonate, aluminum hydroxide, titanium white, titanium dioxide, calcined clay, zinc oxide, barium sulfate, talc, synthetic silica, lithium silicate, diatom earth, magnesium carbonate, magnesium hydroxide, magnesium oxide, mica, natural zeolite, synthetic zeolite, pseudobaymite, hydroxyapatite, intercalation complex, etc. may be used. Out of the inorganic pigments mentioned above, porous synthetic non-crystalline silica and porous synthetic non-crystalline alumina are preferable for the required pore volume and ink absorbability to be obtained. Examples of the method for producing these inorganic pigments include hydrothermal synthesis, coprecipitation, sol-gel and other methods but are not limited to these.

For the inorganic pigment, those pigments which have been subjected to surface treatment, such as surface modification using a coupling agent or an organic material and surface treatment using metal iron exchange, gas-phase deposition and liquid-phase precipitation methods, for the purpose of giving multiple functions. Furthermore, for the purpose of improving print storage stability, the inorganic pigment may be used in the form of pigment slurry impregnated with a radical trapping agent, a reducer, a UV abosorber or an antioxidant so far as such mode of use will not impair the suitability for ink jet printing significantly.

As examples of the water-soluble polymer binder used in the present invention, the following can be cited: for example, polyvinyl alcohol, cationized polyvinyl alcohol, cellulose derivatives such as hydroxyethylcellulose and carboxymethylcellulose, polyvinylpyridine, polyethylene oxide, polypropylene oxide, starch, starch oxide, esterified starch, enzyme-modified starch, cationized starch, sodium alginate, sodium polystyrene sulfonic acid, casein, gelatin, and terpene. Out of these, use of polyvinyl alcohol is preferable from the viewpoint of binder strength, compatibility with the pigment, and viscosity control at the time of preparing the coating agent. In this respect, the saponification degree of polyvinyl alcohol or the degree of polymerization is not particularly limited.

As binders other than these water-soluble polymers, conjugated diene-based polymer latexes such as styrene-butadiene copolymer and methylmethacrylate-butadiene copolymers and vinyl-based polymer latexes such as ethylene-vinyl acetate copolymer may be used together with the aforesaid water-soluble polymer binder. These binders are normally used in the amount of 10 to 50 parts by weight against 100 parts by weight of the pigment, but this ratio is not particularly limited so far as the amount of such binder is adequate for binding the pigment.

The ink receiving layer can be formed on base paper by coating a coating agent made primarily of an inorganic pigment and a water-soluble polymer binder.

For the coating agent used for the ink receiving layer, dispersing agents, antifoaming agents, pH regulators, lubricants, wetting agents, release agents, water retention agents, viscosity improvers, surfactants, antiseptics, softeners, wax, conductivity prevention agents, antistatic agents, sizing agents, insolubilizers, dye fixing agents, plasticizers, fluorescent whitening agents, coloring pigments, coloring dyes, flowability improvers, printability improvers, fragrant materials, deodorants, etc. may be selected and added as required.

The ink receiving layer may be coated as a single or multiple coat on base paper by coating the coating agent prepared as described above by means of such general coating systems as on-machine coater and off-machine coater by using blade coaters, roll coaters, reverse roll coaters, air knife coaters, die coaters, bar coaters, gravure coaters, curtain coaters, Champflex coaters, lip coaters, rod coaters, etc. to obtain the ink jet printing paper of the present invention. In view of the coating agent being a liquid, air knife coaters, curtain coaters and rod coaters, among other coaters, are preferable, and air knife coaters are more preferable.

The ink receiving layer is coated by use of a coater so that the coating amount of the coating agent is approximately 5 to 20 g/m² in terms of dry coating amount on one surface from the viewpoint of the coating amount required for ink jet printing and printing uniformity.

In this respect, a given coating amount of the coating agent may be coated on the ink receiving layer in several installments. As examples of the method in which the coating agent is coated in several installments, a method in which each individual layer is coated and dried and a method in which a multiple layers are coated simultaneously on a wet-on-wet basis can be cited. Furthermore, it is also possible to provide a gloss layer on top of the ink receiving layer by using a cast coater, etc.

The drying method used after coating is not particularly limited, but drying methods, such as hot air drying, infrared drying, normal-temperature drying and freeze drying can be cited as examples of the dry method. However, in light of drying efficiency, infrared drying and hot air drying are preferable.

Furthermore, after the coating of the ink receiving layer, the ink receiving layer may be treated for smoothness by use of calendering equipment such as super calenders, machine calenders and soft nip calenders. However, these calenders should be used within such range that the bulk will not be reduced significantly. The ink jet printing paper of the present invention normally has a sufficient degree of smoothness without carrying out such finishing treatment.

The present invention provides an ink jet printing paper which is bulky and shows high smoothness, brightness and opacity, excellent sharpness of print images and water resistance, and especially superior in ink strike-through and cockling, in comparison with conventional coated-type ink jet printing papers.

It is presumed that since synthetic fiber inhibits the hydrogen bonding of natural fiber, thereby increasing the bulk of the base paper and filling up the voids among the pulp fibers at the same time, the smoothness of the base paper is improved and the smoothness after the coating of the ink receiving layer is also improved, resulting in excellent sharpness of print images.

The blending of synthetic fiber allows the synthetic fiber to play the role of a binder and reduces the formation of ripples due to the swelling of pulp fibers, bringing about an improvement in the cockling problem and the opacity of the base paper, with the result that the problem of ink strike-through is improved.

### EXAMPLES

Given below is a specific explanation of the present invention using Examples, but the present invention is not limited to these Examples.

Further, the terms “parts” and “%” used below mean “parts by weight” and “weight percent”, respectively, unless otherwise specified.

The average fiber length, drainage factor and Canadian freeness as used in connection with the present invention were measured by the methods as described below.

Average Fiber Length

The average fiber length (mm) per unit weight as measured by use of an automatic fiber length measuring device FS-200 available from Kayani of Finland was used as the average fiber length (CFL).

Drainage Factor

The time in seconds required for water to be drained was measured in accordance with the standards of TAPPI-T221 except that the basis weight of the sheet was changed to 500 g/m². The drainage factor is time per g of the pulp.

Canadian Standard Freeness (CSF)

Canadian standard freeness was measured in accordance with JIS P-8121.

### Example 1

Preparation of Base Paper

0.8% of cation starch, 5% talc, 0.3% sizing agent (Coropearl E-5H available from Seiko Kagaku Kogyo Co.) and 0.3% aluminum sulfate were added to a pulp slurry comprising 20 parts of polyolefin-based synthetic pulp (product name: SWP E620 available from Mitsui Chemicals; average fiber length: 1.2 mm; drainage factor: 6 sec/g) and 80 part of LBKP showing a Canadian standard freeness (CSF) of 400 cc. Paper was made from the mixture by use of a Fourdrinier paper-making machine and subjected to size press treatment using the following blended liquid. As a result, an ink jet printing base paper having a basis weight of 70 g/m² was obtained.

Blending of Size Press Liquid

Two parts of polyvinylalcohol (product name: PVA-117 available from Kuraray Co.), 0.3 parts of a surface sizing agent (product name: SS373 available from PMC Japan) and 97.7 parts of water were blended.

Preparation of a Coating Agent For the Ink Receiving Laver

A 20.0% pigment slurry was prepared by use of dispersion equipment by adding 0.2 parts of sodium polyacrylate (product name: Caribon L-400 available from Sanyo Kasei) as a dispersant to 100 part of synthetic non-crystalline silica (product name: Silojet P412 available from Grace Davidson; average particle size: 12.0 μm; average pore volume: 2.0 ml/g). 20 parts of polyvinylalcohol (product name: PVA-117 available from Kuraray Co.), 30 parts of ethylene vinyl acetate (product name: Sumika Flex 401 available from Sumitomo Chemical Co.) and 10 parts of a dye fixing agent (product name: DA-108 available from Seiko Kagaku Kogyo) were added to the aforesaid pigment slurry and agitated to be dispersed. Water was added to it, and as a result, a coating agent having a solid content of 20% was obtained. Formation of the ink receiving laver

The coating agent thus obtained was coated on one side of the aforesaid base paper by means of an air knife coater so that the dry amount of coat was 10 g/m². The coated paper was dried with hot air by use of an air dryer, and as a result the ink jet printing paper of the present invention was obtained.

### Example 2

The ink jet printing paper of the present invention was obtained by the same manner as in Example 1 except that the amount of the polyolefin-based synthetic pulp added in Example 1 was changed to 40 parts.

### Example 3

The ink jet printing paper of the present invention was obtained by the same manner as in Example 1 except that the amount of the polyolefin-based synthetic pulp added in Example 1 was changed to 80 parts.

### Example 4

The ink jet printing paper of the present invention was obtained by the same manner as in Example 2 except that the basis weight of the base paper as mentioned in Example 2 was changed to 100 g/m².

### Example 5

The ink jet printing paper was obtained by the same manner as in Example 1 except that polyester fiber (product name: N801 available from Unitika Ltd.; 1.6 dtex; average fiber length: 3 mm) was used in place of the polyolefin-based synthetic pulp.

### Comparative Example 1

The ink jet printing paper of the present invention was obtained by the same manner as in Example 1 except that the blending ratio of the polyolefin-based synthetic pulp added in Example 1 was changed to 0 parts.

### Comparative Example 2

The ink jet printing paper of the present invention was obtained by the same manner as in Example 1 except that the basis weight of the base paper was changed to 100 g/m².

### Reference Example 1

A commercially available ink jet printing paper of the one-side matte-coated type having a basis weight of 110 g/m² was used.

Evaluation of the Ink Jet Printing Paper

The ink jet printing paper obtained as described above was evaluated as to paper whiteness properties, sharpness of print images, water resistance, ink strike-through and cockling by using the method as described below. Results of the evaluation are shown in Table 1.

For the ink jet printer, PM9000 available from Epson and HP2500 Cp available from Hewlett-Packard were used for printing.

(1) White Paper Properties

The ink jet printing paper was tested in accordance with JIS standards after its humidity was adjusted at 50% RH.

Basis weight: JIS P-8124

Density: JIS P-8118

Beck smoothness: JIS P-8119

Brightness : JIS P-8123

Opacity: JIS P-8138

Tear strength: JIS P-8116

(2) Sharpness of Print Images

The sharpness of print images was checked visually and evaluated according to the following standards:

∘: Print images were very sharp without any blur, and the contrast was clear.

◯: Print images were sharp, and there was contrast.

Δ: Print images were not so sharp, and there was blur and somewhat cloudiness.

×: Print images were not sharp, and there was blur and somewhat cloudiness.

(3) Water Resistance

A printed part was dipped in water for 5 seconds and then wiped with filter paper. The flow-out of ink was evaluated according to the following standards.

∘: There was no flow-out of ink, and water resistance was satisfactory.

◯: The flow-out of ink was not conspicuous, and water resistance was satisfactory.

Δ: The flow-our of ink occurred in secondary color, and water resistance was somewhat low.

×: The flow-out of ink occurred on the whole, and water resistance was very low.

(4) Ink Strike-Through

A printed sample was checked visually for ink strike-through from the back side and evaluated according to the following standards:

∘: The print images on the surface could not be seen through the base paper, and the ink strike-through characteristic is very satisfactory.

◯: The print images on the surface could not be seen very well through the base paper, and the ink strike-through characteristic was satisfactory.

Δ: The print images on the surface were seen to some extent through the base paper, and the ink strike-through characteristic was somewhat unsatisfactory.

×: The print images on the surface were seen through the base paper, and the problem of ink strike-through was noticed clearly.

(5) Cockling

A printed sample was checked visually for cockling from the back side and evaluated according to the following standards:

∘: The printed area was smooth, there was no ripples there.

◯: The printed area was practically smooth, there was only a few ripples there.

Δ: The printed area was somewhat irregular, and there were ripples there.

×: The printed area was significantly irregular, and there were ripples there.

TABLE 1

| | Surface | | | | | | Comparative | Comparative | Reference |
|---|---|---|---|---|---|---|---|---|---|
| | (Direction) | Example1 | Example2 | Example3 | Example4 | Example5 | Example1 | Example2 | Example1 |
| Synthetic fiber | | SWP | SWP | SWP | SWP | PET | — | — | — |
| Synthetic fiber content | | 20 | 40 | 80 | 40 | 20 | 0 | 0 | — |
| (patrts) | | | | | | | | | |
| Basis weight g/m² | | 80.5 | 80.3 | 80.1 | 109.8 | 80.8 | 81.2 | 110.3 | 110.0 |
| Density g/cm³ | | 0.74 | 0.69 | 0.61 | 0.70 | 0.76 | 0.82 | 0.81 | 0.82 |
| Beck smoothness | Top | 55 | 60 | 50 | 62 | 45 | 48 | 47 | 56 |
| (sec.) | Back | 71 | 87 | 52 | 90 | 30 | 19 | 21 | 40 |
| Brightness % | Top | 90.6 | 92.1 | 92.5 | 92.0 | 86.1 | 82.2 | 82.5 | 84.1 |
| | Back | 90.2 | 91.2 | 92.3 | 91.3 | 84.3 | 80.0 | 80.3 | 80.4 |
| Opacity % | | 90.4 | 91.7 | 95.2 | 95.8 | 90.0 | 87.2 | 92.8 | 92.2 |
| Tear strength mN | CD | 460 | 450 | 320 | 580 | 380 | 430 | 530 | 520 |
| PM9000C print test | | | | | | | | | |
| Sharpness of | Top | ⊚ | ⊚ | ◯ | ⊚ | Δ | Δ | Δ | ◯ |
| print images | | | | | | | | | |
| Water resistance | Top | ⊚ | ⊚ | ⊚ | ⊚ | ⊚ | ⊚ | ⊚ | ◯ |
| Ink strike-through | Back | ◯ | ⊚ | ◯ | ⊚ | ◯ | X | Δ | ◯ |
| Cockling | Back | ◯ | ⊚ | ⊚ | ⊚ | ◯ | X | Δ | Δ |
| HP2500CP print test | | | | | | | | | |
| Sharpness of | Top | ⊚ | ⊚ | ◯ | ⊚ | Δ | Δ | Δ | X |
| print images | | | | | | | | | |
| Water resistance | Top | ⊚ | ⊚ | ⊚ | ⊚ | ⊚ | ⊚ | ⊚ | ⊚ |
| Ink strike-through | Back | ◯ | ◯ | Δ | ⊚ | Δ | X | X | Δ |
| Cockling | Back | Δ | ◯ | ⊚ | ⊚ | Δ | X | X | X |

Note:
Top: Coated surface,
Back: Non-coated surface,
CD: Cross-machine direction

Applicability to Industrial Use:

The present invention provides an ink jet printing paper which is bulky and shows high smoothness, brightness and opacity, excellent sharpness and water resistance of print images and especially excellent preventive effect of ink strike-through and cockling in comparison with conventional coated-type ink jet printing papers.

The ink jet printing paper of the present invention also has the advantage of requiring no finishing treatment that is carried out for many of the conventional ink jet printing papers for the purpose of improving their paper carriage properties because the back side of the one-side coated surface of the ink jet printing paper of the present invention is smooth reflecting the smoothness of the base paper.

Since the ink jet printing paper of the present invention uses synthetic fiber and natural fiber, it makes redispersion by water possible.

The present invention provides an ink jet printing paper that can be recycled as waste paper stock after use and is friendly to the environment by contrast to the fact that it was impossible to recycle the film, nonwoven fabric, resin coated paper, etc. used on the conventional large-sized paper printer in many cases.

1. An ink jet printing paper having an ink receiving layer on the base paper, which comprises that the base paper contains synthetic fiber having a branched form.

2. (canceled)

3. The ink jet printing paper according to claim 1 wherein the synthetic fiber having a branched form is synthetic pulp.

4. The ink jet printing paper according to claim 3 wherein the synthetic pulp is polyolefin-based synthetic pulp.

5. The ink jet printing paper according to claim 4 wherein the polyolefin-based synthetic pulp has an average fiber length of 0.1 to 5 mm and a drainage factor of 0.1 sec/g to 20 sec/g.

6. The ink jet printing paper according to claim 5 wherein the aforesaid base paper contains synthetic fiber and natural pulp in a ratio by weight percent of 10/90 to 80/20.

7. The ink jet printing paper according to claim 4 wherein the aforesaid base paper contains synthetic fiber and natural pulp in a ratio by weight percent of 10/90 to 80/20.

8. The ink jet printing paper according to claim 3 wherein the aforesaid base paper contains synthetic fiber and natural pulp in a ratio by weight percent of 10/90 to 80/20.

9. The ink jet printing paper according to claim 2 wherein the aforesaid base paper contains synthetic fiber and natural pulp in a ratio by weight percent of 10/90 to 80/20.

10. The ink jet printing paper according to claim 1 wherein the aforesaid base paper contains synthetic fiber and natural pulp in a ratio by weight percent of 10/90 to 80/20.
